(19) United States
(12) Patent Application Publication
(10) Pub. No.: US 2023/0067518 A1
(43) Pub. Date: Mar. 2, 2023

(54) Microwave Installation Support

(71) Applicant: Keene Fields, Washington, UT (US)

(72) Inventor: Keene Fields, Washington, UT (US)

(21) Appl. No.: 17/460,625

(22) Filed: Aug. 30, 2021

(51) Int. Cl. H05B 6/64; H05B 6/80

(52) U.S. Cl. CPC H05B 6/6429; H05B 6/80

(57) ABSTRACT

A tool that enables a single person to install a microwave oven by securing it to a wall is disclosed. Also disclosed is a method that the microwave oven installer uses.

### FIELD

The present subject matter is directed to a method for using an extendable and retractable tool designed to support a microwave oven during its installation.

### BACKGROUND

U.S. Pat. No. 3,778,013 to Selenke is for an adjustable support for suspending partition walls, brackets for shelving as well as other material, including steps upon which individuals can stand to use the support as a stilt or pogo stick type of device. U.S. Pat. No. 6,612,533 to Biles et al. is for an adjustable support useful to carpenters for installing cabinets and handrails in buildings. U.S. Pat. No. 7,290,742 to Wang is for an adjustable support tool used for vertical or horizontal mounting. U.S. Pat. No. 7,685,689 to Del Castello is directed to an installation tool for a garbage disposal. U.S. Design 740,543 to Winters is directed to an adjustable walking aid. US published application 2020/0337459 to Riegger is for a length-adjustable support mechanism.

While videos available on the internet present an easy-to-install one-person microwave oven wall-mount installation procedure, those professionals who install current microwave ovens know that a wall-mount installation generally requires at least two people. Furthermore, most professional microwave oven installers know, in order to be successful in bidding on jobs to install microwave ovens, that it is essential to have a bid that is low enough not only to secure a contract for the job but also to be profitable. Therefore, to reduce cost it would be desirable for most professional microwave installers that there be a special tool available to enable microwave oven installation to be a one-person procedure. Since known support tools, including support tools described in the paragraph immediately above are unsatisfactory, the present subject matter includes embodiments of an extendable and retractable tool I designed to support a microwave oven during its installation.

### SUMMARY

First, I shall briefly describe my method for mounting a microwave oven to a wall, using an extendable and retractable tool I designed to support a microwave oven during its installation. Then, I shall briefly describe the tool which I designed.

My method includes a number of steps. One step is to secure a mounting bracket to a wall. The microwave oven includes an underside surface having a first edge portion to be located adjacent the wall and a second edge portion spaced outwardly from the wall (and, of course, the first edge portion). The mounting bracket, which is typical for wall-mount applications, includes a lip portion for supporting the first edge portion of the underside surface of the microwave oven above a supporting surface such as a countertop or on top of a flat-surfaced kitchen oven. Another step includes then using the lip portion of the mounting bracket to temporarily support the first edge portion while the second edge portion of the microwave oven is slanted down toward the supporting surface. An additional step next is to pivot the microwave oven temporarily supported by the lip portion of the mounting bracket about an axis defined by the lip portion of the mounting bracket until the underside surface of the microwave oven is oriented approximately parallel to the supporting surface. A further step includes adjusting my extendable and retractable support tool to a length that is substantially equal to a measured distance between the underside surface of the microwave oven and the supporting surface when the underside surface of the microwave oven is oriented approximately parallel to the supporting surface. Still another step includes using my support tool to keep the underside surface of the microwave oven oriented approximately parallel to the supporting surface until an upper surface of the microwave oven is “fixed” to support structure located above the microwave oven.

For most applications, the wall is frequently a planar surface that is oriented approximately 90 degrees relative to the supporting surface. Also, the supporting surface, often an upper surface of a kitchen countertop or a common kitchen oven, can be a surface of a floor, if a microwave oven is mounted, e.g., above a bookcase.

My special tool for enabling a person to easily mount a microwave oven to a wall, and securely attach the microwave oven to kitchen cabinets, has at least one end portion which is extendable and retractable relative to an opposite end portion of the tool. My tool comprises a main body portion which, in certain embodiments, takes the form of an elongated outer cylindrical member defining a hollow interior region bounded by an internal cylindrical surface. The outer member also defines a longitudinal axis. My tool thus includes at least one extendable-and-retractable member which, in certain embodiments, can take the form of an inner cylindrical member axially disposed within the hollow interior region of the outer cylindrical member. The inner cylindrical member provides the tool with a first end portion. The inner cylindrical member includes an external cylindrical surface that is slidably engageable along the longitudinal axis within the internal cylindrical surface of the outer cylindrical member. The outer cylindrical member provides the tool with a second end portion opposite the first end portion. One of the first and second end portions is extendable and retractable along the longitudinal axis relative to the other, for enabling a user such as a microwave oven installer, to adjust the tool length so that it is approximately equal to a measured distance between a bottom surface of the microwave oven and a supporting surface when the bottom surface of the microwave oven is oriented substantially parallel to the supporting surface.

### BRIEF DESCRIPTION OF THE DRAWINGS

FIG. 1A is a front elevational view of a typical wall-mount microwave oven, supported above a cooking surface of a common kitchen oven by an embodiment of a length-adjustable support tool, in accordance with the present subject matter.

FIG. 2A is another front elevational view, showing the length-adjustable support tool presented in FIG. 1A, but on a scale that is enlarged relative to FIG. 1A.

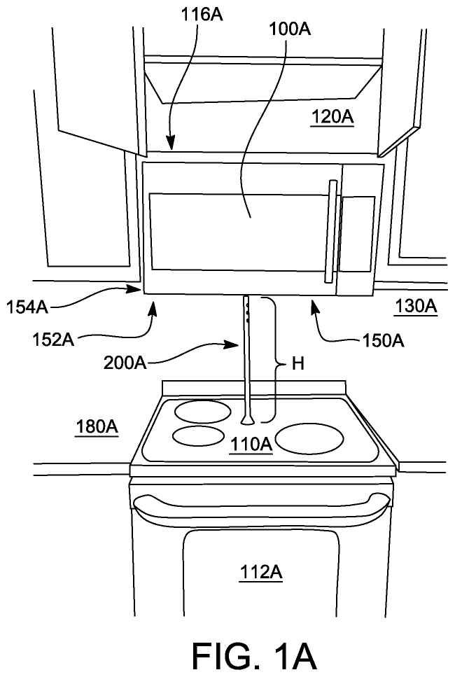

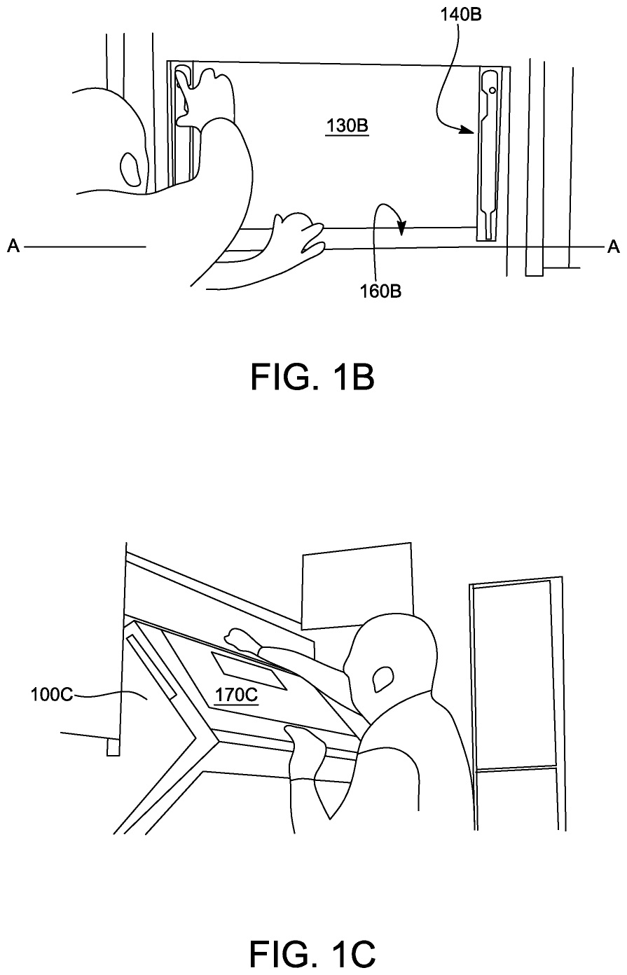

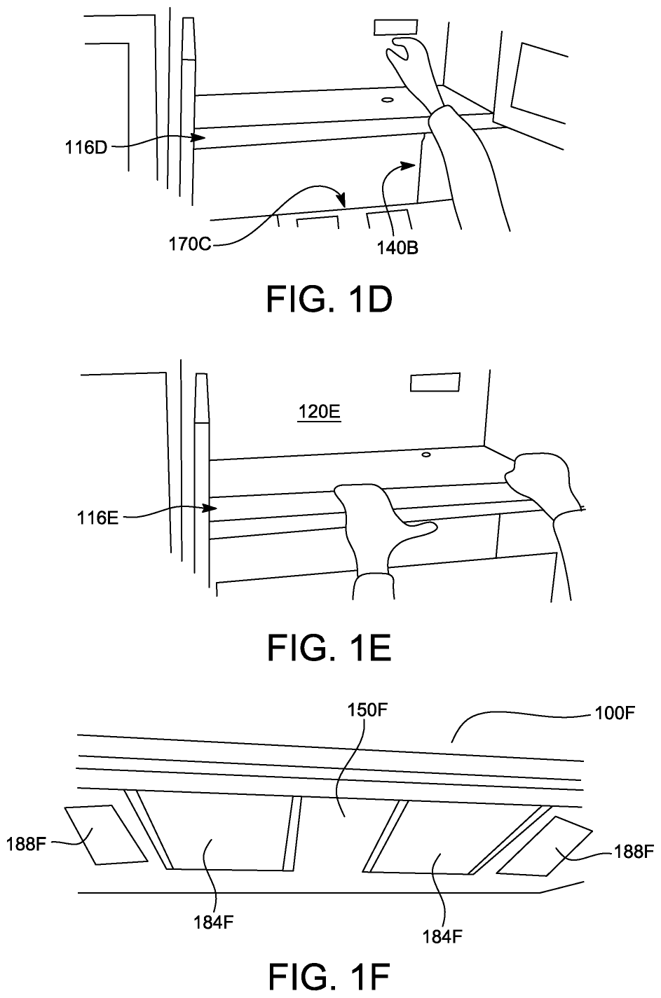

FIGS. 1B, 1C, 1D and 1E are cropped, frontal views of yet another (typical) wall-mount microwave oven, showing certain steps in a typical wall-mount process.

FIG. 1F is also a frontal view of yet another wall-mount microwave oven.

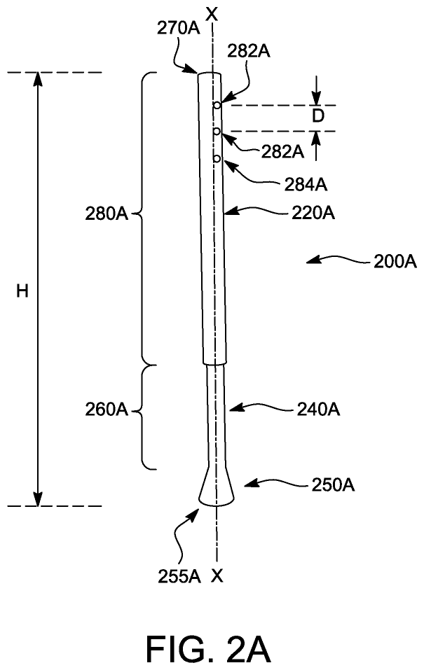

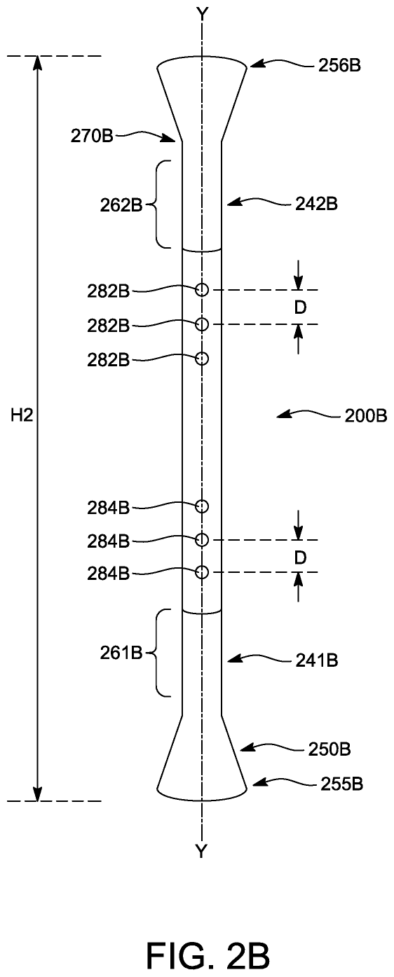

FIG. 2B depicts another embodiment of the support tool shown in FIG. 2A.

Throughout the drawing figures and detailed description below, I shall use similar letters and figures to refer to similar microwave ovens, structure associated with microwave ovens, and similar components of the illustrated embodiments of length-adjustable installation tools, all of which involve the present subject matter.

### DETAILED DESCRIPTION

Many, perhaps most, of the microwave ovens currently commercially available are built-in varieties, countertop varieties, or wall-mount varieties. The present subject matter is directed to the wall-mount variety of microwave ovens.

FIG. 1A presents a typical wall-mounted microwave oven 100A supported above an upper cooking surface 110A of a conventional kitchen oven 112A by an embodiment of an extendable and retractable microwave oven support tool 200A of the present subject matter. The tool 200A, after its length is adjusted, is used to support the microwave oven 100A above the cooking surface 110A, which serves as a supporting surface for the tool 200A, for enabling a single person using the tool 200A to attach the microwave oven 100A, along its upper surface, to a structural component 116A (of, e.g., a kitchen cabinet 120A), serving as a structural support. FIGS. 1B through 1E shall next be used to illustrate typical steps used to mount a conventional microwave oven 100C (see FIG. 1C) to a wall 130B (see FIG. 1B). A first step is to secure a mounting bracket 140B (see FIG. 1B) to the wall 130B.

The microwave oven 100A (see FIG. 1A) includes an underside surface 150A having a first edge portion 152A that is to be mounted adjacent the wall 130A. The microwave oven 100A includes a second edge portion 154A extending from the wall 130A and spaced from the first edge portion 152A (of microwave oven 100A).

The mounting bracket 140B (see FIG. 1B) includes a lip portion 160B for supporting the first edge portion 152A (see FIG. 1A) above a supporting surface 110A such as the upper cooking surface of conventional kitchen oven 112A. When using my tool 200A, a single person wanting to wall-mount a microwave oven 100C (see FIG. 1C), simply uses the lip portion 160B of the mounting bracket 140B (see FIG. 1B) to support the first edge portion 152A (see FIG. 1A) while the second edge portion 154A (see FIG. 1A) is slanted down toward the supporting surface (FIG. 1C).

Another step involves the single person pivoting the microwave oven 100C (see FIGS. 1C through 1E), supported by the lip portion 160B about an axis A-A (see FIG. 1B) defined by the lip portion 160B of the mounting bracket 140B, until the underside surface 150A (see FIG. 1A) of the microwave oven 100A is oriented approximately parallel to the supporting surface 110A of conventional oven 112A.

A further step involves the single person adjusting an embodiment of the extendable and retractable microwave oven support tool 200A (see FIGS. 1A, 2A) of the present subject matter to a length that is substantially equal to a measured distance H (see FIG. 1A) between the underside surface 150A of microwave oven 100A and supporting surface 110A when the underside surface 150A of microwave oven 100A is oriented approximately parallel to surface 110A of kitchen oven 112A.

Another step involves the single person using the length-adjusted tool 200A to support the underside surface 150A of the microwave oven 100A when the microwave oven 110A is oriented approximately parallel to the supporting surface 110A until an upper surface 170C (see FIG. 1C) of the microwave oven 100C is securely “fixed” to a structural support 116E provided, e.g., by a kitchen cabinet 120E (see FIG. 1E) that is located very close and above the microwave oven 100C.

The above steps enabling a single person to attach a microwave oven to a wall above a conventional kitchen oven assume that the wall 130A is essentially a planar surface oriented about 90 degrees relative to the cooking surface 110A or to a kitchen countertop 180A (see FIG. 1A). In addition, another embodiment of a microwave oven wall-mount support tool (not shown) of the present subject matter involves the tool having a length sufficient to provide support, to mount a microwave oven when a supporting surface is an upper surface of a floor in a room. Thus, the support tool of the present subject matter shall have any suitable length.

Referring now to FIG. 2A, an embodiment of a special tool that enables a single person to mount a microwave oven on a wall shall now be described in detail. The tool 200A includes an outer cylindrical member 220A defining a longitudinal axis X-X and a hollow interior region bounded by an internal cylindrical surface.

The tool 200A further includes (see FIG. 2A) an inner cylindrical member 240A that defines a first end portion 250A. The inner cylindrical member 240A also defines an external cylindrical surface 260A which is slidably engageable with the internal cylindrical surface of the outer cylindrical member 220A along axis X-X.

The outer member 220A defines a second end portion 270A opposite the first end portion 250A. One of the first and second end portions 250A, 270A is extendable and retractable along the axis X-X, relative to the other of the first and second end portions 250A, 270A, when the inner member 240A is axially disposed in the hollow interior region of the outer member 220A. This feature enables a user (such as an installer of a typical wall-mounted microwave oven) to adjust a length dimension of the tool 200A to be approximately equal to a measured distance, H (see, FIGS. 1A, 2A), between an underside surface 150A of a microwave oven 100A and a supporting surface 110A when the underside surface 150A of the microwave oven 100A is oriented approximately parallel to the supporting surface.

The inner cylindrical member 240A of the tool 200A defines a hollow interior that contains a known locking mechanism for spacing one of the first and second end portions 250A, 270A, from the other—by a distance that is first selected and then “locked-in-place” by a user—which is approximately equal to the measured distance, H (see FIGS. 1A, 2A). That known locking mechanism which is disclosed in U.S. Pat. No. 4,085,763 to Thomas is hereby incorporated by reference in its entirety.

The outer cylindrical member 220A (please see FIG. 2A) of the tool 200A defines a sidewall 280A and at least one plurality of locking apertures 282A disposed through the sidewall 280A and axially spaced apart along the longitudinal axis X-X of tool 200A. The known locking mechanism contained within the hollow interior of the inner cylindrical member 240A can include at least one radially outwardly-extending spring-biased locking button 284A which is approximately aligned with each of the above-mentioned plurality of locking apertures 282A. The above-mentioned locking button 284A, when moved along longitudinal axis X-X, is engageable with each one of the above-mentioned locking apertures 282A for purposes of enabling a user to adjust a length dimension value or parameter of the tool 200A to be approximately equal to the distance between the microwave oven underside surface and supporting surface, when the microwave oven underside surface is approximately parallel to the supporting surface. Further in accordance with the present subject matter, while FIG. 2A depicts the locking button 284A and associated locking apertures 282A in the foreground, yet another embodiment of the support tool can include a second locking button and associated second plurality of locking apertures spaced 180 degrees about the axis X-X relative to the locking button 284A and associated plural locking apertures 282A shown. In addition, the tool 200A can become a solution to an assortment of microwave oven wall-mount problems by increasing or decreasing a distance D between adjacent apertures 282A, thereby enabling the tool to be adjusted to any desired height, H.

For instance, for wall-mount microwave oven installations, an operative height, H, that ranges from about 18 inches to about 21 inches, or ranges from about 19 inches to about 20 inches, or that is about 19.5 inches, which are typical values for many wall-mount applications, could be achieved. For that purpose, a distance D between adjacent apertures 282A ranging from about 2 mm to about 8 mm, or from about 2 mm to about 6 mm, or that is about 3 mm would be suitable.

The first end portion 250A of the above-described embodiment of tool 200A (see FIG. 2A) of the present subject matter includes a rubber foot or boot 255A that not only provides non-slip support of tool 200A on cooking surface 110A of kitchen oven 112A (see FIG. 1A) but also minimizes damage to the cooking surface 110A.

One variety of a typical microwave oven 100F (see FIG. 1F) has an underside surface 150F that includes filter elements 184F and light fixtures 188F. To avoid damage to filter elements 184F, light fixtures 188A or other structural features on the underside surface 150F of such variety of microwave oven, another embodiment of my extendable and retractable tool 200B (please see FIG. 2B) includes a first rubber boot 255B at its first end portion 250B and a second rubber 256B at its second or opposite end portion 270B. This embodiment of the tool 200B for mounting a microwave oven to a wall, similar to the above described tool 200A, also includes an outer cylindrical member 220B defining a longitudinal axis Y-Y and a hollow interior region that is bounded by an internal cylindrical surface. This embodiment of the support tool 200B, however, differs from the above described embodiment of the support tool 200A, in several ways (see FIG. 2B). For instance, this embodiment of the tool 200B includes two inner cylindrical members 241B and 242B. The first inner cylindrical member 241B includes a first end portion 250B which includes a first foot or rubber boot 255B. The first inner cylindrical member 241B further defines an external cylindrical surface 261B that is slidably engageable along the longitudinal axis Y-Y within one end of the internal cylindrical surface of hollow outer cylindrical member 220B. The second inner cylindrical member 242B defines a second end portion 270B which similarly includes a second foot or rubber boot 256B. The second cylindrical member 242B also defines an external cylindrical surface 262B that is also slidably engageable along the axis Y-Y within an opposite end of the internal cylindrical surface of the hollow outer cylindrical member 220B.

At least one of the end portions 250B, 270B is extendable and retractable along the axis Y-Y relative to the other; and the present subject matter includes each (please see FIG. 2B) of the first and second end portions 250B, 270B being extendable and retractable along the longitudinal axis Y-Y, relative to the other, when the first and second inner members 241B, 242B are axially disposed in the hollow interior region of the outer member 220B at opposite ends thereof. This feature enables a user (such as an installer of a wall-mounted microwave oven) to adjust a length dimension of the tool 200B to be approximately equal to a measured distance, H2 (see FIG. 2B), between an underside surface 150A of a microwave oven 100A and a supporting surface 110A (see FIG. 1A) when the underside surface 150A of microwave oven 100A is oriented approximately parallel to supporting surface. The rubber boot 256B on the upper end portion 270B of the microwave support tool 200B is designed to prevent damage to structural features, including filter elements 184F and light fixtures 188F, present on the underside surface of certain varieties of wall-mounted microwave oven 100F (see FIG. 1F).

What has been illustrated and described is a special tool that I designed to enable a single person to install wall-mounted microwave ovens. While the present subject matter has been described with reference to exemplary embodiments, the present subject matter is not to be limited to them. On the contrary, because many alternatives, changes and modifications will become apparent to those of ordinary skill in the field of the present subject matter upon reading this disclosure, all such alternatives, changes and/or modifications are to be treated as being part of the present subject matter insofar as they fall within the scope of the appended claims.

I claim:

1. A tool for mounting a microwave oven to a wall, comprising:
an outer member defining a longitudinal axis and a hollow interior region bounded by an internal surface; and
an inner member defining a first end portion and an external surface that is slidably engageable with the internal surface of the outer member along the axis,
wherein the outer member defines a second end portion spaced from the first end portion, wherein one of the first and second end portions is extendable and retractable along the axis relative to the other one of the first and second end portions when the inner member is axially disposed in the hollow interior region of the outer member, for enabling a user to adjust a length dimension of the tool to be approximately equal to a measured distance between an underside surface of the microwave oven and a supporting surface when the underside surface of the microwave oven is oriented approximately parallel to the supporting surface.

2. The tool of claim 1, wherein the inner and outer members are cylindrical.

3. The tool of claim 1, wherein one of the inner and outer members includes a locking mechanism for spacing one of the first and second end portions at a predetermined distance value from the other of the first and second end portions.

4. The tool of claim 1, wherein the inner member is cylindrical and defines a hollow interior, wherein the outer member is cylindrical, and wherein the hollow interior of the inner member contains a locking mechanism for spacing one of the first and second end portions from the other of the first and second end portions by a distance approximately equal to the measured distance.

5. The tool of claim 4, wherein the cylindrical outer member defines a sidewall and a plurality of apertures axially spaced apart along the longitudinal axis,
wherein the locking mechanism comprises a radially outwardly-extending spring-biased locking button aligned with one of the plurality of apertures, wherein the locking button is engageable with each one of the plurality of apertures, to cause the length dimension to be approximately equal to the measured distance.

6. The tool of claim 5, wherein the length dimension of the tool ranges from about 18 inches to about 21 inches.

7. The tool of claim 5, wherein the length dimension of the tool ranges from about 19 inches to about 20 inches.

8. The tool of claim 5, wherein the tool length dimension is about 19.5 inches.

9. The tool of claim 5, wherein the length dimension of the tool ranges from about 54 inches to about 60 inches.

10. The tool of claim 5, wherein the length dimension of the tool ranges from about 56 inches to about 58 inches.

11. The tool of claim 5, wherein the tool length dimension is about 57 inches.

12. A tool for mounting a microwave oven to a wall, comprising:
an outer cylindrical member defining a longitudinal axis and a hollow interior region bounded by an internal cylindrical surface;
a first inner cylindrical member defining a first end portion and a first member external cylindrical surface that is slidably engageable with the internal cylindrical surface of the outer cylindrical member along the longitudinal axis; and
a second inner cylindrical member defining a second end portion and a second member external cylindrical surface that is slidably engageable with the internal cylindrical surface of the outer cylindrical member along the axis,
wherein at least one of the first and second end portions is extendable and retractable along the longitudinal axis relative to the other one of the first and second end portions when the first and second inner cylindrical members are axially disposed in the hollow interior region of the outer cylindrical member at opposite ends thereof, for enabling a user to adjust a length dimension of the tool to be approximately equal to a measured distance between an underside surface of the microwave oven and a supporting surface when the underside surface of the microwave oven is oriented approximately parallel to the supporting surface.

13. A method for mounting a microwave oven to a wall, comprising:
securing a mounting bracket to the wall, wherein the microwave oven includes an underside surface having
a first edge portion to be located adjacent the wall and
a second edge portion spaced from the first edge portion, and
wherein the mounting bracket defines a lip portion for supporting the first edge portion above a supporting surface;
using the lip portion of the mounting bracket to support the first edge portion while the second edge portion is oriented toward the supporting surface
pivoting the microwave oven supported by the lip portion about an axis defined by the lip portion of the mounting bracket until the underside surface of the microwave oven is oriented approximately parallel to the supporting surface,
adjusting an extendable and retractable support tool to a length substantially equal to a distance between the underside surface of the microwave oven and the supporting surface when the underside surface of the microwave oven is oriented approximately parallel to the supporting surface, and
using the support tool to keep the underside surface of the microwave oven oriented approximately parallel to the supporting surface until an upper surface of the microwave oven is secured to a structural support closely spaced thereabove.

14. The method of claim 13, wherein the wall is aligned with a planar surface oriented about 90 degrees relative to the supporting surface.

15. The method of claim 13, wherein the supporting surface is an upper surface of a floor.

16. The method of claim 13, wherein the supporting surface is an upper surface of a countertop or an oven.

17. The method of claim 16, wherein the countertop is a kitchen countertop and wherein the oven is a conventional oven.

18. The method of claim 13, wherein the structural support is a kitchen cabinet.

19. The method of claim 16, wherein the structural support is a kitchen cabinet.

20. The method of claim 18, wherein the structural support is a kitchen cabinet.
